(19) United States
(12) Patent Application Publication
(10) Pub. No.: US 2006/0144471 A1
(43) Pub. Date: Jul. 6, 2006

(54) Small log chipper canter

(76) Inventor: Yves Levesque, Saint-Felicien (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/849,933

(22) Filed: May 21, 2004

(30) Foreign Application Priority Data
May 19, 2004 (CA) 2,467,760

(51) Int. Cl. B27C 1/00; B27L 11/00; B27B 1/00; B27C 9/00; B27M 1/08

(52) U.S. Cl. 144/373; 144/378; 144/162.1

(57) ABSTRACT

A chipper canter comprises a log feeding and holding system adapted to carry small diameter logs while the same are being squared. The feeding and holding system permits to reduce the sawing variations and to increase the recuperation of the wood fibres in small diameter logs, thereby rendering economical the use thereof in the production of lumber.

### BACKGROUND OF THE INVENTION

1. Field of the Invention

The present invention generally relates to an apparatus for producing cants from small diameter logs as well as short length logs.

2. Description of the Prior Art

Today's forest reserve is composed to a significantly large extent from small diameter trees previously considered uneconomic for use in producing lumber. The feeding and guiding systems of conventional chipper canters and like wood processing apparatus have been designed for large diameter logs and are, thus, not well adapted for firmly holding and carrying small logs (i.e. logs ranging from about 1½ inches to about 8½ inches in diameter and from about 4 feet to about 6 feet in length), thereby resulting in significant sawing variations and cantmaking defects. Furthermore, known chipper canters are provided with independent positioning and log holding systems, which further limits their ability of properly positioning and holding small diameter logs during the transformation process. The instability of the small diameter logs in the chipper canters increases the efforts that must be supported by the machinery, which leads to premature wear and breaking of some mechanical pieces. The instability of the small diameter logs in the chipper canters also contributes to increase the level of wood which is lost during the transformation process.

Therefore, small diameter logs have been heretofore mostly used in the production of wood chips for the wood pulp industry. The commercial value of sawn lumber being greater than the value of wood chips, it would be very beneficial to economically produce small lumber pieces (e.g. 2×2 and 2×3) from short and small diameter logs.

### SUMMARY OF THE INVENTION

It is therefore an aim of the present invention to provide an apparatus for producing cants and wood chips from small diameter logs.

It is a further aim of the present invention to render economically viable the transformation of small diameter logs into cants.

It is also an aim of the present invention to provide such an apparatus which offers improved cutting accuracy during the squaring operations of small diameter logs.

It is a further aim of the present invention to limit the waste products generated during the production of four-sided cants from small diameter logs.

It is still a further aim of the present invention to provide a chipper canter having an integrated log feeding and guiding system which is particularly adapted to carry and hold small diameter logs while the same are being transformed into cants.

Therefore, in accordance a general aspect of the present invention, there is provided a chipper canter for producing a cant from a small diameter log, comprising an integrated propelling and guiding system for feeding the small diameter log endwise along a predetermined path between at least a first pair of opposed chipper heads, each of said chipper heads carrying a number of cutting blades distributed about a circle, and wherein said predetermined path extends to a peripheral portion of said circle at a position spaced from a central portion thereof with said cutting blades engaging the log at an oblique angle.

In accordance with a further general aspect of the present invention, there is provided a method of canting a log comprising the steps of: a) first removing a major portion of wood fibres from opposed sides of the log by guiding the log between a first pair of chipper heads, and then b) removing a smaller portion of wood fibres than that removed at step a) by guiding the log between a second pair of chipper heads oriented at 90 degrees relative to the first pair of chipper heads in order to produce a four-sided cant.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is an isometric view of a chipper canter adapted to produce four-sided cants from small diameter logs in accordance with a preferred embodiment of the present invention;

FIG. 2 is a side elevation view of a chipper canter shown in FIG. 1;

FIG. 3 is a top plan view of the chipper canter shown in FIG. 1;

FIG. 4 is a rear end view of the chipper canter shown in FIG. 1; and

FIG. 5 is a schematic side view of a chipper head illustrating the cutting angle of the logs in the chipper chipper canter shown in FIG. 1 as compared to the cutting angle of the logs in a conventional chipper canter.

### DESCRIPTION OF THE PREFERRED EMBODIMENTS

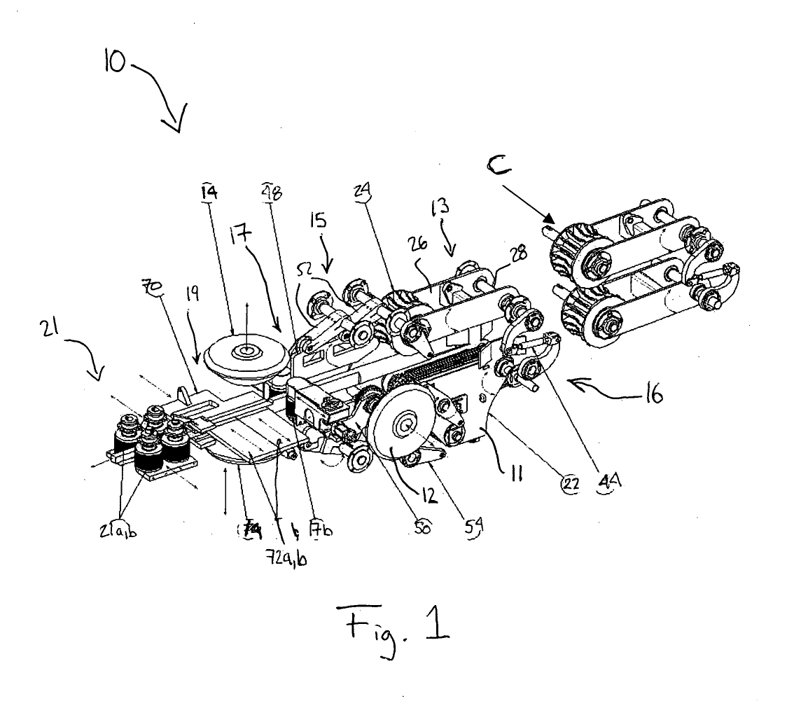

FIG. 1 shows a chipper canter 10 which is particularly well suited for producing four-sided pieces of lumbers or cants (e.g. 2×2, 2×3 and 2×4) from logs having a diameter ranging from approximately 1½ inches to approximately 8½ inches and a length comprised between approximately 4 to 6 feet.

The chipper canter 10 generally comprises a frame 11, a pair of vertically oriented chipper heads 12, a pair of horizontally oriented chipper heads 14 downstream of the vertically oriented chipper heads 12, and a log feeding and holding system 16 adapted to position and to adequately stabilize the logs during the squaring operations in order to obtain a uniform and precise “cutting” of the small diameter log. Unlike conventional chipper canters, the holding system and the feeding system of the present invention are integrated into a single unit (i.e. system 16) forming part of the chipper canter itself. As will be seen hereinafter, one characteristic of the feeding and holding system 16 resides in the fact that the parts which drivingly engage the logs for propelling it endwise are also used to accurately position the logs relative to the chipper heads 12 and 14.

The vertically oriented chipper heads 12 face each other from opposed sides of a central axis of the chipper canter 10 to produce a pair of parallel vertically disposed flat faces on the log as the log is firmly carried endwise by the log feeding and holding system 16. Likewise, the horizontally oriented chipper heads 14 faces each other to produce parallel top and bottom flat faces on the log as the log is firmly carried forward by the log feeding and holding system 16. The above-described arrangement provides for the production of four-sided cants of square or rectangular cross-section.

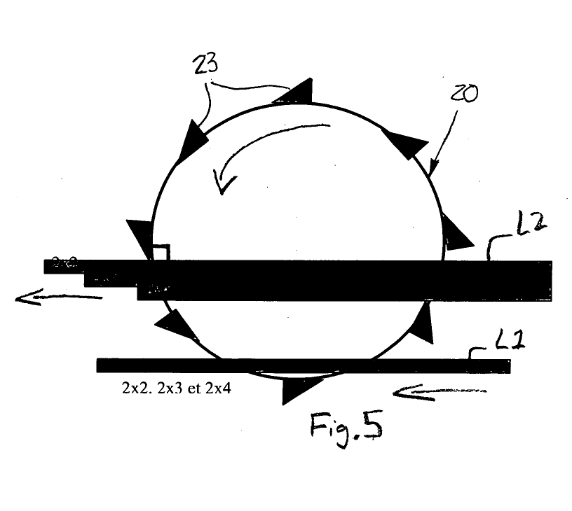

The chipper heads 12 and 14 are of conventional construction and generally include a power driven base member 20 (see FIG. 5) carrying a number of replaceable cutting blades 23 (FIG. 5). The base member 20 is keyed on a shaft driven by a motor, as well know in the art.

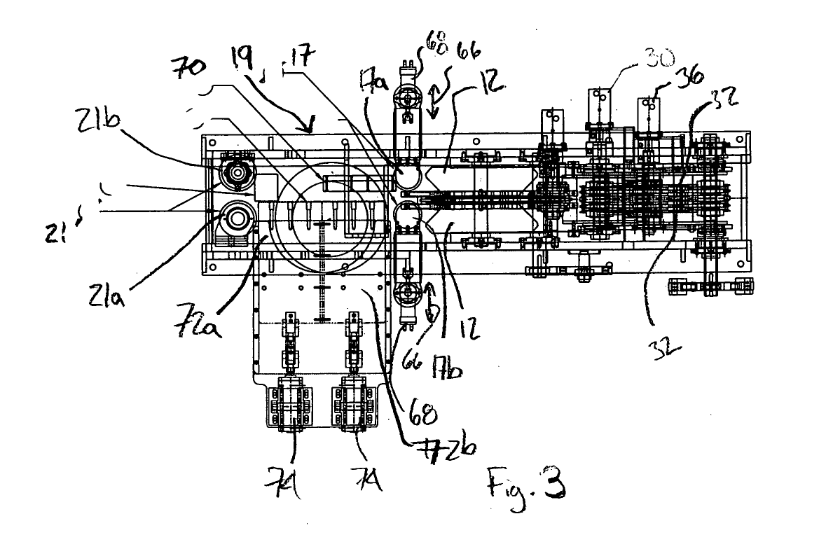

As shown in FIGS. 1 to 3, the combined holding and feeding system 16 generally serially comprises a first unit 13 for aligning the incoming logs midway between the horizontal and vertical chipper canters 12 while at the same time propelling the logs endwise to a second unit 15 adapted to firmly engage top and bottom surfaces of the logs while the same are being vertically planned by the vertical chipper heads 12, a third unit 17 including a pair of horizontally motorized rollers 17a and 17b for “grasping” the logs immediately downstream of the vertically oriented chipper heads 12, a fourth unit 19 adapted to hold the logs by the two opposed flat sides which have been previously defined thereon by the vertically disposed chipper heads 12, and a fifth unit 21 including two sets (only one pair being shown in FIG. 3) of horizontally disposed motorized grooved rolls 21a and 21b for drivingly engaging the flat vertical sides of the logs immediately downstream of the horizontal chipper heads 14.

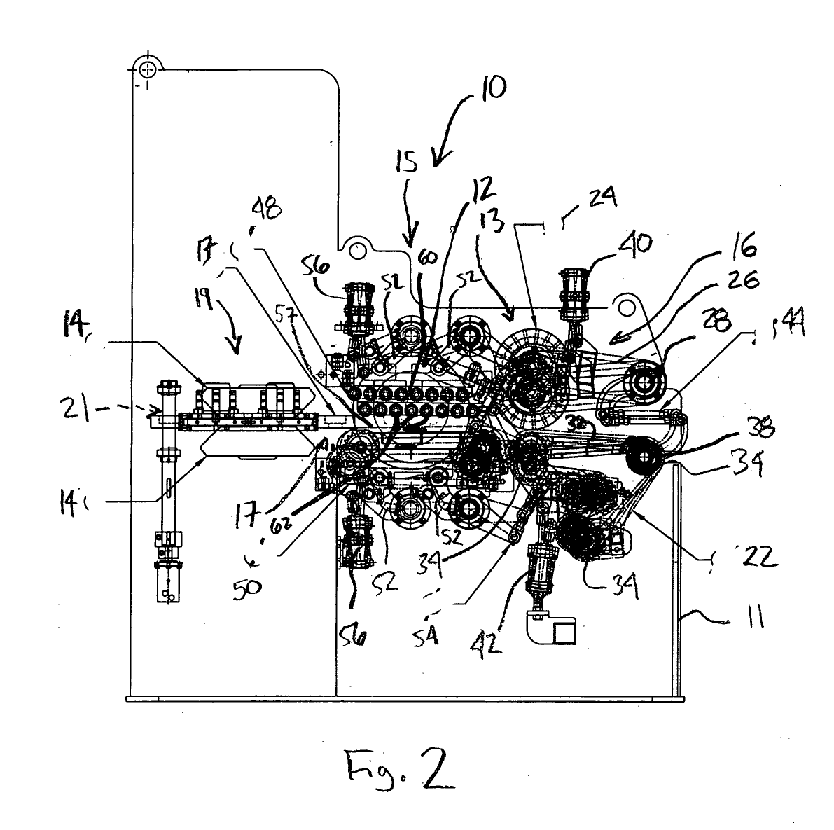

As shown in FIG. 1, the first unit 13 comprises a bottom chain conveyor 22 and a top centralizing roll 24. The centralizing roll 24 is mounted at a distal end of an arm 26 pivotally mounted at 28 to the chipper canter frame 11. The centralizing roll 24 is power driven by a motor 30 (see FIG. 3). The bottom chain conveyor 22 comprises a plurality of laterally spaced-apart chains 32 (FIG. 3) extending over a number of toothed wheels 34 (FIG. 2), one of which is power driven by a second motor 36 (FIG. 3). The bottom chain conveyor 22 is pivotally mounted to the frame 11 at 38 (FIG. 2). Top and bottom pneumatic cylinders 40 and 42 are respectively provided for pivoting the top centralizing roll 24 and the bottom chain conveyor 22 towards and away from one another (see broken lines in FIG. 2). A synchronizing link 44 is pivotally connected at a first end thereof to the top centralizing roll 24 and at a second opposed end thereof to the bottom chain conveyor 22 to cause the top centralizing roll 24 and the bottom chain conveyor 22 to close and open simultaneously.

The external diameter of the centralizing roll 24 gradually decreases toward the center thereof to cause the logs engaged thereby to be brought centrally between the opposed longitudinal ends of the roll 24. This ensures that the logs will always be perfectly centralized between the vertical chipper heads 12. That is to say that the center of each log will be precisely located midway between the vertical chipper head 12. In this way, the same volume of wood will be removed from the logs on each side thereof, and, thus, no unbalanced force will be exerted on the logs which will be more stable, thereby providing for accurate squaring of the logs.

The vertical positioning of the logs is provided through the synchronization of the opening and closing of the top centralizing roll 24 and the bottom chain conveyor 22. The pneumatic cylinders 40 and 42 respectively urge the top centralizing roll 24 and the bottom chain conveyor 22 towards a closed position. As the log becomes engaged between the top centralizing roll 24 and the bottom chain conveyor 22, it forces the top centralizing roll 24 and the bottom chain conveyor 22 to conjointly pivot away from each other with the pneumatic cylinders 40 and 42 maintaining the top and bottom units 24 and 22 in firm contact with the log. The synchronization link 44 ensures that the bottom chain conveyor 22 and the top centralized roll 24 open and close conjointly over a same distance. In this way, the center of the successively incoming logs will always be at the same vertical position in the chipper canter and that irrespective of the diameter of the logs.

While the center of the small diameter log is being properly vertically and horizontally positioned by the first unit 13, the log is simultaneously advanced by the top centralizing roll 24 and the bottom chain conveyor 22 towards the second unit 15 which is adapted to firmly hold the log from above and below while at the same time propelling the log between the vertically disposed chipper heads 12. The second unit 15 comprises a top log engaging member 48 and a bottom log engaging member 50 mounted generally between the vertically oriented chipper heads 12. The top and bottom log engaging members 48 and 50 are movably mounted to the frame 11 by double swing arms 52 in a parallelogram arrangement for up and down swinging movement as depicted by the broken lines in FIG. 2. A synchronizing link 54 extends between the top and bottom log engaging members 50 and 52 to ensure conjoint movement thereof. As for the first unit 13, two pneumatic cylinders 56 working at constant pressure are provided for maintaining the top and bottom log engaging members 48 and 50 in firm engagement with logs of various diameters. The top and bottom log engaging members 48 and 50 are adapted to firmly engage the log to prevent the same from moving to the right or to the left while the log is being processed by the vertical chipper heads 12, which would result in a greater volume of wood being removed from one side of the log.

Proper holding of the small diameter log between the vertical chipper heads 12 can be achieved by providing the bottom log engaging member 50 in the form of a chain conveyor having a central chain 57 with teeth or log grippers distributed along the length thereof for providing improved traction on the log. A motor 58 (FIG. 3) is provided for driving the toothed chain 57. The top log engaging member 48 is preferably provided in the form of a steel plate 60 carrying a row of longitudinally spaced-apart rollers 62 machined in the form of concave diamonds. The rollers 62 act on the log to maintain it against the bottom chain conveyor in order to ensure that the log be appropriately propelled forward through the apparatus.

The distance between top and bottom log engaging members 48 and 50 is greater at the inlet end thereof than at the outlet end thereof in order to follow the natural taper of the log and to offer a better holding when two small diameter logs are successively engaged between the top and the bottom log engaging members 48 and 50.

As depicted by arrows 66 in FIG. 3, the motorized rollers 17a and 17b of the third unit 17 are mounted for reciprocating movement towards and away from the central axis of the chipper canter 10. A pair of pneumatic cylinders 68 is provided for holding the rollers 17a and 17b in driving engagement with the opposed sides of the log at the exit of the vertically oriented chipper heads 12.

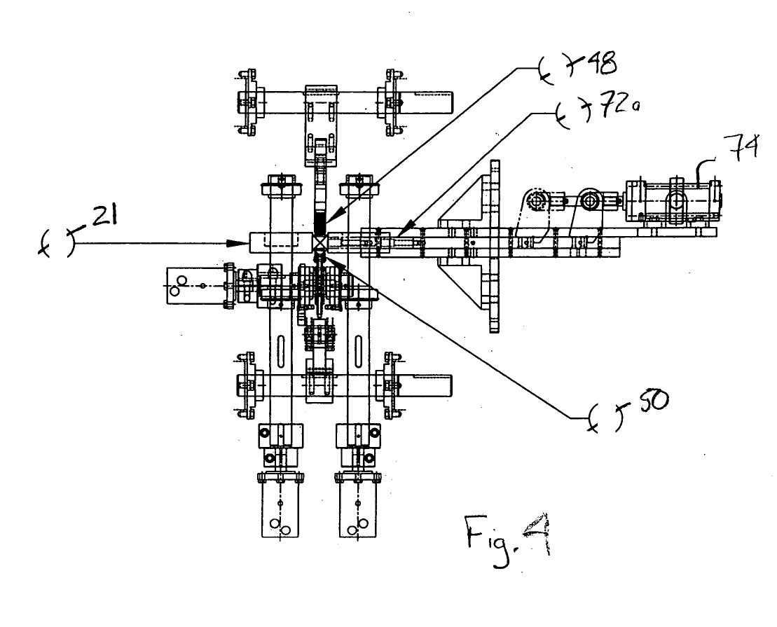

The fourth unit 19 is located immediately downstream of the motorized rollers 17a and 17b for firmly holding the sides of the log while the top and bottom surfaces thereof are being processed by the horizontal chipper heads 14. As shown in FIGS. 3 and 4, the fourth unit 19 comprises a fixed shoe 70 and a pair of side-by-side mobile shoes 72a and 72b cooperating together to push the partly squared log against the fixed shoe 70 while the log is being moved forward between the horizontal chipper heads 14. A pair of pneumatic cylinders 74 is provided for independently moving the mobile shoes 72 and 72b towards and away from the fixed shoe 70. The mobile shoes 72a and 72b cooperate with the fixed shoe to frictionally hold the logs therebetween in order to prevent the log from moving upwardly or downwardly while it travels between the horizontal chipper heads 14.

At its exit from the horizontal chipper heads 14, the log is drivingly engaged on opposed sides thereof by the motorized grooved rolls 21a and 21b of the fifth unit 21. The rolls 21a and 21b are mounted on a rubber base for maintaining an adequate pressure between the produced cant and the rolls 21a and 21b.

As shown in FIG. 5, one aspect of the present invention resides in the fact that the feed path defined by the holding and feeding system 16 extends at the periphery of the circle on which the cutting blades 23 are distributed. This ensures that the cutting blades 23 will engage the log L1 at an oblique angle rather than at right angles as when a log L2 is processed in a conventional chipper canter. By so feeding the log L1 at the periphery of the chipper heads 12 and 14, the wood fibres are cut as opposed to being crushed. This is because the blades 23 cut the wood along the fibre direction as opposed to a direction which is perpendicular thereto, as illustrated in the case of Log L2.

irrespective of the nominal width of the cant to be produced (2 inches, 3 inches or 4 inches), the feed path remains at the periphery of the chipper heads 12 and 14 (at the position occupied by log L1 in FIG. 5) and does not become closer to the central portion of the chipper heads 12 and 14 as is the case with conventional chipper canters. Indeed, according to the prior art, the smaller the log diameter, the more the log is brought near the center of the chipper heads, which results in additional vibrations, sawing variations and wood fibre losses.

Also according to the present invention, the greater volume of wood fibres is removed at the first pair of chipper heads, i.e. when the weight of the log and dimension thereof are maximal. This facilitates holding of the log and contributes to reduce the vibrations during the squaring process. In contrast, the prior art teaches removing the major portion of the wood after the log has been squared on two faces. This only leaves a small contact surface for holding the log to subsequently remove a more important portion of wood fibres on the two other sides thereof.

In use, a small diameter log is brought between the top centralizing roll 24 and the bottom chain conveyor 22 by an entry conveyor C such as the one shown in FIG. 1. The roll 24 and the chain conveyor 22 will equally pivot away from each other in accordance with the diameter of the log to thereby automatically vertically position the center of the log relative to the chipper heads 12 and 14. The top centralizing roll 24 ensures that the log be appropriately horizontally positioned relative to the chipper heads 12 and 14. The top centralizing roll 24 and the bottom chain conveyor 22 respectively exert traction on the top and bottom surfaces of the log to propel the same forward between the top and bottom log engaging members 48 and 50 of the secondary unit 15. The top and bottom log engaging members 48 and 50 firmly hold the log while a portion of the sides of the log is being chipped away by the vertical chipper heads 12. The material removed from the log is recuperated as wood chips. The resulting two-faced cant is propelled forward by the bottom engaging member 50 and the motorized rollers 17a and 17b to the fourth unit 19 where the two-faced cant is held laterally between the movable shoes 72a and 72b and the laterally opposed fixed shoe 70. The pressure exerted by the fixed shoe 70 and the mobiles shoes 72a and 72b on the opposed machined sides of the two-faced cant prevents the two-sided cant from moving vertically, while being machined on the top and bottom surfaces thereof by the horizontally disposed chipper heads 14. At its exit from the horizontal chipper heads 14, the cant is engaged on the sides thereof by the grooved rolls 21a and 21b before being guided outside of the chipper canter 10.

The above-described chipper canter 10 is advantageous in that it provides for accurate squaring of small diameter logs. It permits to produce small pieces of lumber (2×2, 2×3 and 2×4) of better quality and at a lower cost. It provides for the production of small sawn lumber (2×2 and 2×3) from small diameter logs that were, in the past, only used to produce wood chips, which have a significantly inferior commercial value.

According to the present invention, the diameters of the logs are measured mechanically by the holding and feeding system 16, thereby obviating the need for costly scanning and measuring systems.

The embodiments of the invention described above are intended to be exemplary. Those skilled in the art will therefore appreciate that the forgoing description is illustrative only, and that various alternatives and modifications can be devised without departing from the spirit of the present invention. Accordingly, the present is intended to embrace all such alternatives, modifications and variances which fall within the scope of the appended claims.

1. A chipper canter for producing a cant from a small diameter log, comprising an integrated propelling and guiding system for feeding the small diameter log endwise along a predetermined path between at least a first pair of opposed chipper heads, each of said chipper heads carrying a number of cutting blades distributed about a circle, and wherein said predetermined path extends to a peripheral portion of said circle at a position spaced from a central portion thereof with said cutting blades engaging the log at an oblique angle.

2. The chipper canter as defined in claim 1, wherein said integrated propelling and guiding system comprises a first pair of log engaging members adapted to drivingly engage the log therebetween to propel the log endwise between said at least one pair of chipper heads, and wherein said first pair of log engaging members comprises first and second log engaging members biased towards a closed position and conjointly movable at unison towards an open position against a biasing force in response to the engagement of the log therebetween, thereby automatically ensuring that the center of the log will always be at the same location in an opening and closing plane of the log engaging members irrespectively of the diameter of the log, wherein at least one of said first and second log engaging members is power driven, and wherein said first log engaging member is configured to laterally align the log along a desired endwise direction in a plane perpendicular to the opening and closing plane of the first and second log engaging member.

3. The chipper canter as defined in claim 2, wherein said first log engaging member includes a centralizing roll having first and second opposed ends, a diameter of said roll being minimal at midway between said first and second opposed ends.

4. The chipper canter as defined in claim 3, wherein said centralizing roll is provided in the form of an overhead power driven roll adapted to drivingly engage a top surface of the log.

5. The chipper canter as defined in claim 4, wherein said second log engaging member includes a power driven bottom conveyor mounted below said overhead power driven roll for drivingly engaging a bottom surface of the log.

6. The chipper canter as defined in claim 5, wherein said overhead power driven roll and said bottom power driven conveyor are mounted for pivotal movement towards and away from each other, and wherein a link extends between said overhead power driven roll and said bottom power driven conveyor to ensure conjoint movement of said overhead power driven roll and said bottom power driven conveyor over a same distance.

7. The chipper canter as defined in claim 1, wherein said integrated propelling and guiding system includes first and second pairs of log engaging members for guiding and propelling the log endwise between said at least one pair of chipper heads, the second pair being located downstream of the first pair and extending longitudinally at least partly between said at least one pair of chipper heads for holding the log while the same is being processed by said at least one pair of chipper heads, wherein the first and second pair each include first and second log engaging members biased towards a closed position and conjointly movable at unison towards an open position against a biasing force in response to the engagement of the log therebetween, and wherein at least one of said first and second log engaging members of said second pair is power driven to propel the log endwise.

8. A chipper canter as defined in claim 1, further comprising a second pair of chipper heads, the second pair of chipper heads being oriented at right angles relative to the first pair of chipper heads, the first and second pairs of chipper heads cooperating to transform the log into a four-sided cant, wherein the first pair of chipper heads is arranged to remove a greater volume of wood from the log than said second pair of chipper heads.

9. A chipper canter as defined in claim 7, wherein said first log engaging member of said second pair includes a chain conveyor, and wherein said second log engaging member of said second pair includes a series of rollers.

10. A chipper canter as defined in claim 9, wherein said rollers are machined in the form of concave diamonds.

11. A chipper canter as defined in claim 7, wherein a pair of power driven rolls is disposed to drivingly engage the log immediately downstream of said first pair of chipper heads, said pair of power driven rolls being reciprocally movable in a plane perpendicular to said first pair of chipper heads.

12. A chipper canter as defined in claim 11, wherein said pair of power driven rolls are located between said first pair of chipper heads and a second pair of chipper heads, and wherein said integrated propelling and guiding system further comprises a pair of opposed facing shoes for guiding the log as the same is being processed by said second pair of chipper heads.

13. A chipper canter as defined in claim 12, wherein said opposed facing shoes includes two side-by-side mobile shoe members mounted for reciprocal movement in plane parallel to said second pair of chipper heads.

14. A chipper canter as defined in claim 13, wherein said opposed facing shoes include a fixed shoe member, said side-by-side mobile shoe members being operated by independent cylinders for urging the log against said fixed shoe members has the log is advanced between said second pair of chipper heads.

15. A chipper canter as defined in claim 12, wherein a second pair of power driven rolls are provided downstream of said second pair of chipper heads.

16. A method of canting a log comprising the steps of: a) first removing a major portion of wood fibres from opposed sides of the log by guiding the log between a first pair of chipper heads, and then b) removing a smaller portion of wood fibres than that removed at step a) by guiding the log between a second pair of chipper heads oriented at 90 degrees relative to the first pair of chipper heads in order to produce a four-sided cant.

17. A method as defined in claim 16, wherein each chipper head is provided at a peripheral portion thereof with a number of cutting knives, and wherein the log is guided at said peripheral portion of the chipper heads such that the cutting knives engages the log at an oblique angle.
